(19) United States
(12) Patent Application Publication
(10) Pub. No.: US 2014/0274235 A1
(43) Pub. Date: Sep. 18, 2014

(54) Grain Bin Constructed of Plastic Panels

(71) Applicant: AGCO CORPORATION, Duluth, GA (US)

(72) Inventor: Bryan S. Claerhout, Hesston, KS (US)

(73) Assignee: AGCO CORPORATION, Duluth, GA (US)

(21) Appl. No.: 13/833,034

(22) Filed: Mar. 15, 2013

(51) Int. Cl. A01F 12/00; B29D 99/00

(52) U.S. Cl. CPC A01F 12/00; B29D 99/001
USPC 460/59; 264/238

(57) ABSTRACT

In one embodiment, a method of forming a grain storage bin for a combine harvester, the method comprising forming, in a plastic molding process, plural double-walled plastic panels of the grain storage bin; and coupling the plural double-walled plastic panels in an interlocking arrangement.

### TECHNICAL FIELD

The present disclosure is generally related to agriculture technology, and more particularly, grain storage bins for combine harvesters.

### BACKGROUND

Combine harvesters are provided with a processing system comprising a combine core and a cleaning system. The combine core comprises one or more rotors used to thresh and separate grain. Within the cleaning system, oscillating sieve assemblies in conjunction with air flow remove the chaff from the threshed grain, the latter falling through the chaffer and sieve assembly to an oscillating clean grain pan. The clean grain pan, in turn, directs the clean grain to a discharge auger that elevates the grain to an onboard grain storage bin. A second oscillating pan directs materials other than grain over the edge of the bottom sieve assembly to a different discharge outlet for recirculation back through the threshing, separating and cleaning assemblies of the processing system to extract the previously unthreshed grain.

The grain storage bin is generally a welded, bolted, or riveted steel structure coupled to the chassis of the combine harvester and comprises several parts for support and containment of grain.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates in a front perspective view an example embodiment of a combine harvester.

FIG. 2 is a schematic diagram that illustrates in a front perspective, fragmentary view an example embodiment of a front portion of a combine harvester with an embodiment of a grain storage bin comprising plural double-walled plastic panels.

FIG. 3A is a schematic diagram that illustrates in a front perspective view an embodiment of interlocking double-walled plastic panels for a grain storage bin.

FIG. 3B is a schematic diagram that illustrates in an overhead plan view an embodiment of the interlocking double-walled plastic panels of FIG. 3A.

FIG. 4A is a schematic diagram that illustrates in a front perspective view an embodiment of double-walled plastic panels with corner supports for a grain storage bin.

FIG. 4B is a schematic diagram that illustrates in an overhead plan view an embodiment of the double-walled plastic panels with a corner support from FIG. 4A.

FIG. 4C is a schematic diagram that illustrates in an overhead plan view an embodiment of the double-walled plastic panels with the corner support of FIG. 4B with the interior of the corner support shown in phantom.

FIG. 5 is a flow diagram that illustrates an embodiment of a method of forming a grain storage bin for a combine harvester.

### DESCRIPTION OF EXAMPLE EMBODIMENTS

### Overview

In one embodiment, a method of forming a grain storage bin for a combine harvester, the method comprising forming, in a plastic molding process, plural double-walled plastic panels of the grain storage bin; and coupling the plural double-walled plastic panels in an interlocking arrangement.

### Detailed Description

Certain embodiments of a combine harvester having a grain storage bin comprised of plural double-walled plastic panels that may be assembled together in an interlocking arrangement are disclosed. The double-walled plastic panels are molded according to a well-known plastic molding process, such as rotational molding, thermoforming, blow-molding, injection molding, etc. In one embodiment, the double-walled plastic panels may be formed in the plastic molding process in a manner where one set of panels (e.g., one pair, such as front and back panels) each comprises an extending member along opposing side edges of the respective panel, and another set of panels (e.g., a pair of opposing side panels) each comprises a recess along opposing side edges of the panel. For instance, the extending member of one double-walled plastic panel may be inserted into a recess of another, adjacent double walled plastic panel, providing a secure and conformal (e.g., frictional) fit. In this regard, the panels are collectively interlocking, reducing the cost of assembly. In other words, the structure of plural (e.g., four (4)) double-walled plastic panels is achieved through the use of mechanically fitting adjacent panels together according to a respective conformal fit that results in a secure structure (e.g., interlocked structure). In another embodiment, such interlocking among the plural double-walled panels may be achieved through the use of an intervening corner support disposed between two adjacent panels. For instance, the corner support may comprise slot openings on each side of the corner support body, enabling an edge of one panel to slidably and conformably fit inside one slot opening and an edge of another adjacent panel (e.g., adjacent when arranged in the completed structure) to slidably and conformably fit in the opposing slot opening, resulting an interlocking arrangement among the two double-walled plastic panels and the corner support in this example.

Digressing briefly, traditional grain storage bins of combine harvesters comprise a welded, bolted, or riveted steel structure comprising several parts for support and containment of grain. Such large assemblies have many parts, and take considerable time to assemble. In certain embodiments of combine harvesters disclosed herein, the grain storage bin is comprised of a double-walled, plastic material (or blend, such as a blend of polyethylene and nylon), reducing or eliminating the quantity of sheet-type parts used to contain the crop material (e.g., grain). Further, the plastic material removes or mitigates problems sometimes associated with some metal surfaces (e.g., steel), such as rust and/or corrosion, and/or reduces the coefficient of friction normally associated with conventional bins, enabling shapes more conducive to grain flow and hence to more efficient grain clean out. Also, by molding the double-walled panels individually (e.g., as separable panels), some of the logistical constraints associated with the molding of a single plastic grain bin assembly may be addressed. For instance, the sheer size of a one-piece, double-walled bin may introduce cost constraints associated with the molding tool, and provide a risk of scrapping an entire molded piece for a localized and small defect. When considering delivery, an entire one-piece grain storage bin may not fit into a closed semi-trailer, and approximately only twelve (12) grain storage bins may fit on a fifty-three (53) foot flatbed. By breaking the formation and assembly of the grain storage bin into smaller parts or panels that can be interlockingly coupled together, one or more benefits may result, including enabling different molding techniques to be used in a cost-effective manner, improving shipping and/or storage density, adding more mechanisms to address thermal expansion, and facilitating the servicing and/or quality control measures of parts.

Having summarized certain features of combine harvesters comprised of plural, separable double-walled plastic panels for a grain storage bin of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on a combine harvester having a transverse-rotor design, though it should be appreciated within the context of the present disclosure that combine harvesters of other designs, such as hybrid, conventional, axial, or dual axial, may be used and hence are contemplated to be within the scope of the present disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly.

Referring now to FIG. 1, shown is an example embodiment of a combine harvester 10 having a grain storage bin comprised of plural double-walled plastic panels that may be assembled together in an interlocking arrangement. It should be understood by one having ordinary skill in the art, in the context of the present disclosure, that the example combine harvester 10 shown in FIG. 1 is merely illustrative, and that other combine configurations may be implemented in some embodiments. The example combine harvester 10 is shown in FIG. 1 without a header, and from front to back, comprises a feeder house 12 and an operator cab 14, followed by a processing system 16 that includes a plurality of components collectively embodied in a combine core (e.g., with threshing and separating functionality) and a cleaning system. In operation, the combine harvester 10 includes a harvesting header at the front of the machine that cuts crop materials and delivers the cut crop materials to the front end of the feeder house 12. Such crop materials are moved upwardly and rearwardly within and beyond the feeder house 12 by a conveyor 18 until reaching a thresher rotor 20 of the processing system 16. The thresher rotor 20 comprises a single, transverse rotor, such as that found in a Gleaner® Super Series Combine by AGCO, though some embodiments may have a dual rotor or axial or hybrid configuration. The thresher rotor 20 processes the crop materials in known manner and passes a portion of the crop material (e.g., heavier chaff, corn stalks, etc.) toward the rear of the combine harvester 10 and another portion (e.g., grain and possibly light chaff) to a cleaning system of the processing system 16 to undergo a cleaning process, as described below. In some embodiments, such as in axial flow designs, the conveyor 18 may convey the cut crop material to a beater before reaching a rotor or rotors.

In the processing system 16, the crop materials undergo threshing and separating operations. In other words, the crop materials are threshed and separated by the thresher rotor 20 operating in cooperation with certain elements of a rotor cage 22, for instance, well-known foraminous processing members in the form of threshing concave assemblies and separator grate assemblies, with the grain (and possibly light chaff) escaping through the concave assemblies and the grate assemblies and onto one or more distribution augers 24 located beneath the processing system 16. Bulkier stalk and leaf materials are generally retained by the concave assemblies and the grate assemblies and are disbursed out from the processing system 16 and ultimately out of the rear of the combine harvester 10. The distribution augers 24 uniformly spread the crop material that falls upon it, with the spread crop material conveyed to accelerator rolls 26. The accelerator rolls 26 speed the descent of the crop material toward a cleaning system 28. Also shown is a transverse, air blowing apparatus 30 (e.g., fan, or equivalently, a blower), which discharges pressurized air through one or more ducts, such as ducts 32 (e.g., which in one embodiment, includes an upper duct and lower duct, as explained below, though not limited to two ducts) to the cleaning system 28 to facilitate the cleaning of the heavier crop material directly beneath the accelerator rolls 26 while causing the chaff to be carried out of the rear of the combine harvester 10. The cleaning system 28 includes plural stacked sieves 34 (e.g., also referred to herein as an oscillating sieve assembly), through which the fan 30 provides an additional push or influence (through a lower duct 32, as explained below) of the chaff flow to the rear of the combine harvester 10.

The cleaned grain that drops to the bottom of the cleaning system 28 is delivered by an auger 36 that transports the grain to a well-known elevator mechanism (not shown, but located on the right hand side of the combine harvester 10), which conveys the grain to a grain storage bin 38 located at the top of the combine harvester 10 (shown in FIG. 1 with flaps, though some embodiments may omit the flaps). In one embodiment, the grain storage bin 38 (hereinafter, also merely referred to as “bin”) is comprised of plural and separable, double-walled plastic panels with interlocking edge features. In some embodiments, the double-walled plastic panels may comprise edges suitable for fitting in slots of corner supports, as explained below. The bin 38 may be comprised of plural, double-walled panels comprised of plastic material, where in some embodiments, all upright panels may be comprised of the same plastic material or in some embodiments, the plastic material may be different between one side and another (e.g., of higher quality plastic material than another side). In some embodiments, a bottom floor panel of the bin 38 may be comprised of single-walled or double-walled plastic or other material, such as metal (e.g., steel) that the bin is secured to (or rests on). In some embodiments, the bottom floor panel of the bin 38 may be configured to enable interlocking coupling between the floor panel and the bottom surfaces of the upright panels of the bin 38. Further description of the bin 38 is provided below.

Continuing with the components and operation of the combine harvester 10, any remaining chaff and partially or unthreshed grain is recirculated through the processing system 16 via a tailings return auger 40. Also shown is a pivoting grain unloading spout 42 (shown in the stored position) encompassing an auger 44 that cooperates with a cross auger (not shown, but disposed beneath a portion of the bin 38) to unload the processed grain from the combine harvester 10 to another vehicle. As should be appreciated by one having ordinary skill in the art, the combine harvester 10 also comprises a chassis 46 to which the wheels, drivetrain, steering assemblies, bin 38, cab 14, and processing system 16, among other components, are coupled. As combine processing and its associated components are known to those having ordinary skill in the art, further discussion of the same is omitted here for brevity.

FIG. 2 is a schematic diagram of a front portion of the combine harvester 10 and an embodiment of the bin 38. Note that the flaps (e.g., plastic components formed from the plastic molding process (or comprised of other material) to expand the grain storage capacity) of the bin 38, among other features not pertinent to the following description and shown in FIG. 1 are omitted here for brevity. In some embodiments, as indicated above, there may be no flaps used in association with the bin 38. The bin 38 is comprised of plural double-walled plastic panels that are arranged in interlocking manner to collectively form a storage container, which is generally polygonal in shape; to facilitate the deposit and high capacity storage of grain processed by the processing system 16 (FIG. 1). As indicated above, the plural, double-walled plastic panels of the bin 38 may be formed through a well-known plastic forming/molding process, such as a rotational molding process (also, roto-molding or roto-mold process), among others, such as injection molding, blow molding, thermoforming, etc. The bin 38 may be formed according to a plurality of different geometric configurations and/or sizes, with one goal toward achieving a compatible fit to the now-replaced metal grain storage bin (or in some embodiments, occupying a smaller space). In one embodiment, the space between the dual walls of each panel may comprise a single compartment (or be segregated into plural compartments, such as via processes inherent in the molding process, including kiss-offs) having a defined fluid storage volume for the storage of fluid. The fluid may be used for a given subsystem (e.g., engine/drivetrain, coolant system, catalytic converter, brake system, steering system, etc.) of the combine harvester 10, such as fuel (e.g., diesel), hydraulic fluid, window wash fluid, diesel exhaust fluid (DEF) (e.g., for selective catalytic reduction (SCR) systems), among other fluids that are compatible with plastic materials. It should be appreciated within the context of the present disclosure that not all panels of the bin 38 are necessarily molded using the same plastic material, and that some panels may be comprised of a material different than another panel. In addition, some portions of the bin 38 may be comprised of non-plastic material in some embodiments, such as a floor panel (e.g., comprised of metal, although some embodiments may use single or double-walled plastic floor panels). In some embodiments, all or a portion of the space between the two walls of a given panel of the bin 38 may be occupied with an insulating material, such as to provide a more manageable control of temperature for the fluid or fluids of adjacent panels (or adjacent compartments whether within the same or different panel). Inlet and outlet ports may be located on top and bottom side, respectively (or in upper and lower portions of a given panel) of one or more panels of the bin 38 to enable the ingress and egress of any fluid occupying the dual walls.

Referring to FIG. 3A, shown is one embodiment of a bin 38 (with a floor panel removed to focus on the interlocking features of the upright panels) comprised of four (4) interlocking double-walled plastic panels. It should be appreciated within the context of the present disclosure that some embodiments may have additional panels that make up the bin 38, and that the generally rectangular geometrical configuration is one example among other possible configurations for the bin 38. The bin 38 comprises, from fore to aft, upright front and rear double-walled plastic panels 50 and 52, and opposing, upright double-walled plastic side panels 54 (left hand side) and 56 (right hand side). In one embodiments, the side panels 54 and 56 are the same or similar in configuration, comprising a perimeter dimension (e.g., length around each entire panel) that is the same or substantially the same. The front panel 50 is depicted as having a longer perimeter dimension (e.g., length around the panel) than the more-truncated, rear panel 52. In one embodiment, the front panel 50 comprises an aperture 58, such as for enabling an operator residing in the cab 14 (FIG. 1) to observe the grain filling or discharging process of the bin 38. It should be appreciated within the context of the present disclosure that some embodiments may have additional apertures, or apertures located elsewhere, and/or additional support structures (e.g., ribs, stairs, etc.). A space 60 is shown where a floor panel (and/or trough) would otherwise be situated. For instance, the floor panel may be secured to the undersides of the panels 50-56 and arranged with one edge (adjacent the rear panel 52) at a higher elevation than the opposing edge (e.g., adjacent the front panel 50), with an aperture disposed on the floor panel to enable the exposure of a cross auger (e.g., residing in a trough) to the interior space of the bin 38 to convey the grain to the auger 44 (FIG. 1) of the unloading spout (42) for discharge to another vehicle. The floor panel may be comprised of double-walled plastic, single-walled plastic, or other non-plastic material (e.g., metal). In some embodiments, the floor panel may comprise interlockable edges, which may include structural members extending from the top surface (e.g., interior to the bin 38) or L-shaped edges that enable a slidable, conformal fit with bottom surfaces of the panels 50-56.

Each of the panels 50-56 comprises opposing upright edges, such as edges 62 and 64 for the front panel 50, with an edge configuration that enables an interlocking engagement with adjacent panels (e.g., side panel 56 and side panel 54, respectively). For instance, and referring to FIG. 3B (with continued reference to FIG. 3A), shown is an overhead plan view of the edge 62 of the front panel 50 in interlocking arrangement (yet not necessarily entirely inserted in some embodiments) with the side panel 56. In particular, the edge 62 of the panel 50 comprises an extending member 66 (e.g., of double-walled construction that conformably and slidably fits within a recess 68 (or equivalently, a slot) of an edge 70 of the adjacent side panel 56. In some embodiments, the extending member 66 may be comprised of a single-walled construction. In the embodiment depicted in FIGS. 3A and 3B, the side panels 56 and 54 each comprise opposing side edges with a generally curvilinear or rounded outside configuration, such as rounded portion 72 of the side panel 56. Also depicted in the embodiment of FIG. 3A (and partially in FIG. 3B) are front and rear panels 50 and 52, each having opposing side edges with extending members, such as the extending member 66 of the front panel 50 as shown in FIG. 3B. It should be appreciated that in some embodiments, different configurations may be used to achieve a similar interlocking coupling, such as where a given panel may have different edges, or where the fore and aft panels 50 and 52 may have the rounded configuration with a recess on the side edges and the opposing side panels 54 and 56 have the extending members on opposing side edges. As shown in FIG. 3B, the edge 70 of the side panel 56 proximal the rounded portion 72 comprises the recess 68 that slidably receives the extending member 66 of the adjacent front panel 50, causing an interlocking arrangement between the two panels 50 and 56. A similar manner of interlocking occurs with the other panels of the bin 38.

In some embodiments, the double-walled panels 50-56 of the bin 38 may be further secured by external securing mechanisms, such as a clamp that secures (and couples to) the top of the panels 50-56 to the bottom floor panel, and/or a basket that surrounds and secures the panels 50-56 to oppose any outward forces (such as via a loaded bin 38). In some embodiments, such external securing mechanisms may be omitted. In some embodiments, one or more interfering structures may be included (e.g., formed according to the panel-forming process) to mitigate loosening of the panels from each other, such as ribs on the outside surfaces of the extending member 66 (or disposed on the surface of the recess 68), among other well-known mechanisms. In one embodiment, the recess 68 is deep enough to ensure a secure and snug fit between the extending member 66 and the recess 68.

Attention is now directed to FIG. 4A, which shows in perspective another embodiment of a bin 38 (the floor panel omitted), where a space 76 is shown and understood to be occupied by a floor panel in operation. Similar to the embodiment of FIG. 3A, the floor panel may be secured to the panels of the bin 38 and configured according to many different possibilities, as described above, and hence description of the same is omitted here for brevity. The bin 38 comprises plural (e.g., four (4)), upright double-walled plastic panels, including front panel 78, rear panel 80, left side panel 82, and right side panel 84. One or more of the panels 78-84 (and the floor panel) may have one or more apertures and/or other structures, as should be appreciated by one having ordinary skill in the art in the context of the present disclosure. In addition, one or more of the panels 78-84 may be configured for fluid storage within one or more compartments disposed between the dual walls of the respective panel. The panels 78-84 are arranged together in interlocking manner through the use of plural corner supports 86, 88, 90, and 92. The corner supports 86-92 enable slidable coupling or engagement of the edge of one panel and the edge of an adjacent panel (e.g., adjacent when in completed form). For instance, in FIG. 4A, and referring to panels 78 and 84, the corner support 92 slidably receives an edge 94 (e.g., side edge) of the front panel 78 and an edge 96 (e.g., side edge) of the adjacent side panel 84, enabling the front and side panels 78 and 84 to be arranged in interlocking manner.

Referring to FIG. 4B, shown is one example embodiment (in overhead plan view) of the corner support 92, having a body with a generally rounded exterior portion 98 and a relatively linear interior portion 100. It should be appreciated within the context of the present disclosure that the geometrical configuration is merely one example among other possible configurations for the corner support 92. In one embodiment, the corner support 92 is comprised of a metal material (e.g., steel), though other non-metal material may be used in some embodiments. The corner support 92 is depicted in FIG. 4B with the front panel 78 and the side panel 84 partially inserted in the corner support 92.

Turning attention to FIG. 4C, shown is the corner support 92 with an internal slot 102 shown in phantom. Though depicted in a generally tubular configuration, the slot 102 may be configured according to other geometries in some embodiments suitable to slidably receive (and secure, such as via conformal, frictional fit) the panels. The panels 78 and 84 are depicted in FIG. 4C as partially inserted in the slot 102, relying on a conformal, frictional fit to secure the panels 78 and 84 in the corner support 92. The securement of the panels 78 and 84 is enhanced as the panel edges are inserted deeper into the slot 102. In some embodiments, interfering structures may be provided on the ends of the panels or on the surfaces of the slot 102 to further secure the panels 78 and 84 in the slot 102 (e.g., to avoid or mitigate loosening of the assembled structure). Although the slot 102 is depicted in FIG. 4C as a contiguous structure, in some embodiments, plural slots (not contiguous with each other) may be used.

Although certain embodiments disclosed herein use double-walled plastic panels, in some embodiments, there may be a mix of types of panels in a given bin 38 (FIG. 1), such as the use of different plastic material, mix of single-walled and double-walled panels, or a mix of plastic and non-plastic material.

Having described various embodiments of a bin 38 (FIG. 1) having different interlocking configurations of double-walled plastic material panels, it should be appreciated in view of the present disclosure that one embodiment of a method of forming a grain storage bin for a combine harvester, the method shown in FIG. 5 and denoted with reference numeral 104, comprises forming, in a plastic molding process, plural double-walled plastic panels of the grain storage bin (106); and coupling the plural double-walled plastic panels in an interlocking arrangement (108).

Any process descriptions or blocks in the flow diagram should be understood as representing steps in a process, and alternate implementations are included within the scope of the embodiments in which additional steps may be included.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A combine harvester, comprising:
a chassis;
a processing system coupled to the chassis, the processing system comprising threshing, separating and cleaning components; and
a grain storage bin supported by the chassis, the bin configured to store crop material processed by the processing system, wherein the bin comprises plural separable and double-walled plastic panels, wherein a first of the plural panels comprises a recess along a first edge and a second of the plural panels adjacent to the first panel comprises an extending member along a second edge, the recess and extending member formed in a process associated with molding the plural double-walled plastic panels, wherein the extending member conformably fits within the recess.

2. The combine harvester of claim 1, wherein the conformal fit enables thermal expansion, manufacturing tolerances, or a combination of both.

3. The combine harvester of claim 1, wherein the plural double-walled plastic panels are molded according to one of a plurality of plastic molding processes.

4. The combine harvester of claim 3, wherein the one of the plurality of plastic molding processes comprises a rotational molding process.

5. The combine harvester of claim 1, further comprising an additional panel that has an interior surface that abuts against lower edges of the plural double-walled plastic panels.

6. The combine harvester of claim 5, wherein the additional panel is arranged on the combine harvester with one edge at a higher elevation than an opposing edge.

7. The combine harvester of claim 5, wherein the additional panel is comprised of a non-plastic material.

8. The combine harvester of claim 1, wherein one panel of a pair of the plural double-walled plastic panels has a different perimeter dimension than the other panel of the pair.

9. The combine harvester of claim 1, wherein one pair of the plural double-walled plastic panels has the same per-panel perimeter dimension.

10. The combine harvester of claim 1, wherein one of the plural double-walled plastic panels is comprised of a different material than another of the plural double-walled plastic panels.

11. The combine harvester of claim 1, further comprising an interfering structure molded onto either the extending member, in the recess, or a combination of both, the interfering structure inhibiting decoupling of each of the plural double-walled plastic panels from one another.

12. A combine harvester, comprising:
a chassis; and
a grain storage bin supported by the chassis, the bin comprising a corner support disposed between a first double-walled plastic panel and a second double-walled plastic panel, the corner support configured to slidably receive a first edge of the first double-walled plastic panel and a second edge of the second double-walled plastic panel, the corner support operably securing the first and second double-walled plastic panels together.

13. The combine harvester of claim 12, wherein the corner support comprises a contiguous slot with first and second slot openings, the first slot opening configured to receive the first double-walled plastic panel, the second slot opening configured to receive the second double-walled plastic panel.

14. The combine harvester of claim 13, wherein the corner support comprises a first slot and a second slot, the first slot comprising a first opening configured to receive the first double-walled plastic panel, the second slot comprising a second opening to receive the second double-walled plastic panel.

15. The combine harvester of claim 13, wherein the corner support is comprised of metal.

16. The combine harvester of claim 13, further comprising a plurality of additional corner supports, wherein the corner support and the additional corner supports are arranged to operably secure the first and second double-walled plastic panels together with two other double-walled plastic panels.

17. The combine harvester of claim 16, further comprising an additional panel that has an interior surface that abuts against lower edges of the first and second double-walled plastic panels and the two other double-walled plastic panels.

18. The combine harvester of claim 17, wherein the additional panel is arranged on the combine harvester with one edge at a higher elevation than an opposing edge.

19. A method of forming a grain storage bin for a combine harvester, the method comprising:
forming, in a plastic molding process, plural double-walled plastic panels of the grain storage bin; and
coupling the plural double-walled plastic panels in an interlocking arrangement.

20. The method of claim 19, wherein the coupling comprises either slidably fitting each panel to adjacent panels or slidably fitting each adjacent panel of the formed grain storage bin to an intervening corner support.
